(19) United States
(12) Patent Application Publication
(10) Pub. No.: US 2004/0003287 A1
(43) Pub. Date: Jan. 1, 2004

(54) Method for authenticating kerberos users from common web browsers

(76) Inventors: Vasileios Bill Zissimopoulos, San Francisco, CA (US); James Roskind, Redwood City, CA (US)

Correspondence Address: GLENN PATENT GROUP, 3475 EDISON WAY, SUITE L, MENLO PARK, CA, 94025, US

(21) Appl. No.: 10/185,255

(22) Filed: Jun. 28, 2002

(51) Int. Cl. H04L 9/00

(52) U.S. Cl. 713/201

(57) ABSTRACT

The invention provides a system and method for authenticating Kerberos users on common web browsers. In the system, a normal web browser is capable of rendering HTML and optionally running JavaScript. A web server acts as a gateway that converts information from the normal browser to normal Kerberos traffic and a Kerberos distribution center (KDC) maintains Kerberos user accounts.

### BACKGROUND OF THE INVENTION

1. Technical Field

The invention relates generally to Internet based authentication technology and more particularly to a method for authenticating Kerberos users from common web browsers.

2. Description of the Prior Art

To complete an electronic transaction on Internet, a user has to go through an authentication process. In other words, the user must provide the seller or service provider with some information such as his personal identification, contact information, or even financial information. The authentication process may take from several seconds to hours. Because each seller or service provider maintains its own authentication server and database, millions of sellers and service providers might share thousands or millions of consumers or users. Some of the consumers or users might be required to go through the same or substantially similar authentication process again and again if they have transactions with many sellers or service providers. This repetitive authentication not only wastes consumers' precious time, but also burdens the sellers or service providers because they have to expand their databases to keep detailed authentication information for a growing number of users. This situation brings forth a technical need to create a universal, unified, single-logon infrastructure wherein a specific user may be authenticated once for all, where the authentication result is widely recognized by a large number of sellers or service providers.

In responding to that need, several approaches have been developed. For example, Microsoft Corporation has introduced a “.NET Passport” single sign-in system. With “.NET Passport”, a user does not need to register a member name and password at each new site he visits. The user may simply use his e-mail address and password that registered as his “.NET Passport” to sign in to any participating site or service. The information the user registers with “.NET Passport” is stored online, securely, in the “.NET Passport” database as the user's “.NET Passport profile.” When the user signs on to a “.NET Passport” participating site by typing his e-mail address and password in the “.NET Passport” sign-in box, “.NET Passport” confirms that (1) the e-mail address he typed is registered with “.NET Passport”, and (2) the password he typed is correct. “.NET Passport” then notifies the site that the user has provided valid “sign-in credentials,” and he is given access to the participating site. Once the user signs in to one “.NET Passport” participating site during an Internet session, he can sign in to other sites simply by clicking the “.NET Passport” sign-in button on each site.

Another example is America Online Incorporated “Screen Name Service” system, which provides free service allowing anyone with a “Screen Name” to easily and securely register at a variety of Web sites. As with to Microsoft's “.NET Passport” system, the “Screen Name Service” eliminates a user's need to remember multiple names and passwords for all the places he visits on the Web. With the “Screen Name Service” system, each user has a “My Profile”, which stores the user's personal information used to make registering at sites across the Web simple and secure. When the user registers at a participating Web site using the service, he has the opportunity to choose which fields of information stored by AOL, if any, he would like to share with that site. No information is shared with any Web site without the user's explicit permission. When the user agrees to share certain information with a participating site, that information is conveyed to the Web site at which he is registering. Another feature is that the user is provided with a “My Site List”, which is an effective way to manage personal information because it shows the user with which sites he has registered with using the service. The user can view the privacy policy of a site to see how it uses information it knows about the user. The user can also decide if he would like to be signed into the site without being prompted and if the site should be updated with information if “My Profile” changes.

The common characteristic of these approaches is that they implement a centralized solution for authentication and authentication information management. Undoubtedly, the centralized solution may overcome the repetitive authentication and repetitive storage problems that exist in the scattered, disorganized situation.

However, the centralized solution has three major disadvantages. First, in a centralized authentication system, because all the login requests go to a central authentication server, the traffic to the server could be very heavy, the requirements for the process capability and database size could be predictably high, and the authentication process would be very slow if the number of requests overwhelms the server. Second, if the central authentication system fails, all the authentication requests would be suspended. Third, the central authentication service provider could monitor the participating sites' logon rates and a site which hosts a user's login page could monitor the user's logon information.

### SUMMARY OF THE INENTION

America Online Inc. has developed a system and method for providing distributed authenticating service, called Magic Carpet Network (MCN). In this system, the user names are chosen from a fairly universal name space, e.g., communication addresses, and yet the servicing of the authentication, e.g. password checking, is distributed among the participants of an authentication federation that the system supports. Typically, the participants are commercial servers that can host authentication. A key goal of this distributed system is to prevent any single participant from monitoring the logon rates of other participants. Most critically, there is no single central list that is consulted to identify where the authentication should be carried out.

FIG. 1A is a block diagram illustrating an exemplary network 100, named Magic Carpet Network (MCN), which provides distributed authentication service among a global authentication federation. The MCN network includes a number of clients, e.g. client device 101, and a number of authentication servers, e.g. servers 111˜113, which are communicatively connected via the Internet 102. Each authentication server represents a participant of the global authentication federation and has a database, e.g. DB 01˜DB 03, which caches its registered users' identification information and any authentication token from other participating authentication servers. Each client or authentication server can access a local domain name server, which is one of many domain name server's coupled in a domain name system (DNS) 110.

FIG. 1B is a schematic diagram illustrating an exemplary domain name system 110 incorporated in a global network. A domain name system (DNS) is a general-purpose, replicated, distributed data query service for looking up host Internet Protocol (IP) addresses based on host names. It is hierarchical, consisting of domains, sub-domains, sites, and hosts. Unique names are formed from smallest to largest, and are of the form user@host.site.subdomain.domain, where host and site are often optional. On the Internet, domain names typically end with a suffix denoting the type of site. For example, “.COM” for commercial sites and “.ORG” for organizations. A name resolution client, such as the client 101 in FIG. 1A, can be configured to search for host information in the following order: first in the local/etc/hosts file, second in network information service (NIS), and third in DNS. This sequencing of naming services is sometimes called name service switching. DNS can be queried interactively using command nslookup.

The MCN network 100 illustrated in FIG. 1A is registered under a unique domain name, for example MCN.ORG, in the central location of the DNS. The MCN, network 100 requires each participant to register its authentication server as an individual machine under the MCN domain. In other words, the host names of the authentication servers share a common suffix. For example, AOL, as a participant host, registers its authentication server as AOL.COM.MCN.ORG under the unique domain MCN.ORG. The domain name server DNS 06 associated with the MCN network 100 just treats each participant authentication server as a host machine. For example, it treats AOL.COM.MCN.ORG as the host name of AOL Authentication Server 111.

As illustrated in FIG. 1C, the database DB 16 associated with the domain name server DNS 06 maintains a list of fully qualified domain names (FQDN) for the registered authentication servers. A FQDN consists of its local host name and its domain name, including a top-level domain. For example, AOL.COM.MCN.ORG is a FQDN, in which AOL.COM is a host name, MCN.ORG is a domain name, and .COM is a top level domain name. Each of FQDN has a unique Internet Protocol (IP) address, which was installed in the database DB 06 when a commercial participant of the federation registered its authentication server under the domain MCN.ORG.

Client 101 is empowered with an interface that enables a user to interact with a distributed authentication system embodied in the MCN network 100. The client 101 includes a browser 103 which displays HTML file. The HTML facilitates a number of functions, including the authentication function, which is typically implemented in JavaScript. Alternatively, the client 101 may include an application specifically for managing the authentication process.

To initiate an authentication process, a user must log in the distributed authentication system by entering his global user identification (Login ID) and password and clicking a login button. A Login ID is in a universal name space format, for example, an email address format. Thus, any given Login ID consists of two portions separated by a delimitation symbol, such as @. The first portion is the user's user name, and the second portion is a domain name indicating the domain of a server (such as AOL.COM) with which the user registered. For example, an AOL registered user with a user name, joe, should enter his Login ID joe@AOL.COM and his password secret911 for authentication by AOL Authentication Server 111, which is registered as AOL.COM.MCN.ORG under the domain MCN.ORG.

Referring back to FIG. 1B, assuming the user enters his Login ID and password from a page 201 hosted by ZYX.COM. Once the user is logged in, the client portion of the authentication system parses the user's Login ID joe@AOL.COM and extracts the domain portion AOL.COM from the Login ID. Then, it appends the MCN domain name as a suffix to the domain portion. As a result, a FQDN AOL.COM.MCN.ORG is formed.

The client portion of the authentication system first looks up a local domain name server DNS 05 to find location of the authentication server with a FQDN AOL.COM.MCN.ORG. After it fails in DNS 05, it populates the lookup request to its upper level DNS 02; after it fails in DNS 02, it populates the lookup request to the top DNS 01, where it locates the DNS 03 for the “.ORG” network, and further locates the DNS 06 for the MCN network 100, and eventually it locates AOL.COM.MCN.ORG. In responding to the lookup request from the client 101, the DNS system returns the unique IP address for AOL.COM.MCN.ORG to the client 101. This unique IP address is automatically cached in the DNS along the returning route, i.e. DNS 06→DNS 03→DNS 01 DNS 02→DNS 05. Note that the critical point is that the DNS lookup is distributed and ached, and as a result, the DNS lookups cannot be centrally monitored by any participant of the federation.

The distributed authentication system supported by the MCN network 100 may include a default server 114 with a FQDN DEFAULT.MCN.ORG. If the DNS lookup totally fails, i.e. the domain included in the lookup request sent by the client device 101 is not recognized by the DNS, a DNS resolver in the central location of the DNS can automatically map the unrecognized domain to the default server 114. The default server 114 takes responsibility to authenticate the user by looking up its local database. The end result is that all possible MCN ID's are automatically distributed to the appropriate servers.

Once the client 101 receives the IP address of the targeted authentication server, i.e. AOL Authentication Server 111 in this example, it sends the user's user name joe with his password secret911 to AOL Authentication Server 111 for authentication. When AOL Authentication Server 111 receives the request, it looks up its local database DB 01 for the user entry, validates the user name and password, and sends an authentication token back to the user. The authentication token is cached in the client device. When the user sends request to any participant servers, the authentication token is automatically attached. The attached authentication token is recognized by any participant server of the federation and is automatically cached in the participant server's database when the participant server receives the authentication token. In this way, the user's detailed authentication information is stored only in one participant server's authentication database, but the authentication token is distributed all over the participants' authentication databases. Because an authentication server does not need to store every user's detailed authentication information, its authentication database can be relatively small in size.

In one option, the client portion of the authentication system has a mapping list of the fully qualified domain names (FQDN) for all registered authentication servers. When the user gets logged in, the system parses and extracts the domain portion from the user's Login ID, and directly checks the mapping list to find the IP address for the target authentication server. If the local list checkup fails, the authentication request may be automatically mapped into the default authentication server 114, as described above.

In another option, the local list checkup and the DNS lookup may be combined. For example, the system first checks the local mapping list. If the target authentication server's IP address is not found from the mapping list, then start the DNS lookup process. If the DNS lookup fails, then automatically map the unrecognized domain to the default server 114 as described above.

In another option, all participants are not registered in a specific domain. Instead, each participating authentication server is registered with a standard server name in its main server's domain. For example, AOL Authentication Server 111 has a FQDN AUTH.AOL.COM, USPTO's authentication server has a FQDN AUTH.USPTO.GOV, etc. In other words, the host names of these authentication servers share a common prefix, but they reside in different domains. When the user gets logged in, the authentication system first parses and extracts the domain portion of the Login ID. Then, it either checks a local mapping list or looks up the DNS 200 or performs both local list checkup and DNS lookup to locate the IP address for the target authentication server. If the IP address for the target authentication server is not found, the system may map the authentication request to the default server 114.

The invention provides a solution for single login authentication from common web browsers based on the Kerberos system.

Kerberos is an authentication service, allowing users and services to authenticate themselves to each other. Based on the key distribution model developed by Needham and Schroeder (“Using Encryption for Authentication in Large Networks of Computers”, Communications of the ACM, Vol. 21), Kerberos was designed to eliminate the need to demonstrate possession of private or secret information, i.e. password, by divulging the information itself. A key is used to encrypt and decrypt short messages, and is itself typically a short sequence of bytes. Keys provide the basis for the authentication in Kerberos. An encryption routine takes an encryption key and a plaintext message, and returns ciphertext. This ciphertext is typically a random stream of bytes. Conversely, the decryption routine takes a decryption key and the ciphertext, and if decryption is successful, returns the original plaintext. The encryption key and the decryption key can be identical or different.

FIG. 2A is schematic diagram showing how a Kerberos works. A client 101 tries to make use of the service 105 and the service 105 wants assurance that the user is who he says he is. The user presents a ticket that is issued by a Kerberos authentication server (AS) 104. The service 105 then examines the ticket to verify the identity of the user. If all checks out, then the user is authenticated. The ticket must contain information linking it unequivocally to the user. It must also demonstrate that the bearer of the ticket knows something only its intended user would know, such as a password.

Both the client 101 and the service 105 are required to have keys registered with the AS 104. The user's key is derived from a password that he chooses; the service key is a randomly selected key. For the purpose of this explanation, imagine that messages in communication are written on paper instead of being electronic, and are encrypted by being locked in a strongbox by means of a key.

The authentication process takes the following steps:

1. First the user, e.g. Bill User, sends a request to the AS 104: “I, Bill User, would like to talk to, e.g. Jim Server.”

2. Upon receipt of the request, AS 104 makes up two copies of a brand new key. This is called session key, which is used in the direct exchange between the user 101 and the service 105.

3. AS-104 puts one of the session keys in Box 1, along with a piece of paper with the name “Jim Server” written on it. It locks this box with the user's key. The box is just an encrypted message, and that the session key is just a sequence of random bytes. If Box 1 only contained the session key, then the user would not be able to tell whether the response came back from the AS 104, or whether the decryption was successful. By putting in “Jim Server” the user (or more precisely, the user's program) is able to verify both that the box comes from the AS 104, and that the decryption was successful.

4. AS 104 puts the other session key in Box 2, along with a piece of paper with the name “Bill User” written on it. It locks this box with the service's key.

5. AS 104 returns Box 1 and Box 2 to the user 101.

6. The user 101 unlocks Box 1 with his key, extracting the session key and the paper with “Jim Server” written on it. The user 101 is unable to open Box 2 because it is locked with the service's key.

7. The user 101 puts a piece of paper with the current time written on it in Box 3, and locks it with the session key extracted from Box 1. He then sends Box 2 and Box 3 to the service 105.

8. The service 105 opens the Box 2 with its own key, extracting the session key and the paper with “Bill User” written on it. It then opens Box 3 with the session key to extract the piece of paper with the current time on it. These items demonstrate the identity of the user.

The timestamp is put in Box 3 to prevent someone else from copying Box 2 and using it to impersonate the user at a later time. Because clocks do not always work in perfect synchrony, a small amount of leeway, e.g. five minutes, is given between the timestamp and the current time. In addition, the service 105 maintains a list of recently sent authenticators, to make sure that they are not resent in quick order. Without need of a password, the service is able to open Box 3 because the service key is not derived from a password. Instead, it is randomly generated, then stored in a special file called a service key file. This file is assumed to be secure, so that no one can copy the file and impersonate the service to a legitimate user.

In Kerberos parlance, Box 2 is called “ticket” and Box 3 is called “authenticator.” The authenticator typically contains more information than what is described above. There may also be an encryption key in the authenticator to provide for privacy in future communications between the user 101 and the service 105.

Sometimes, the user 101 may want the service 105 to be authenticated in return. To do so, the service 105 takes the timestamp from the authenticator (Box 3), places it in Box 4, along with a piece of paper with “Jim Server” written on it, locks it with the session key, and returns it to the user.

There is a subtle problem with the above exchange. It is used every time a user wants to contact a service. But notice that he then has to enter in a password (unlock Box 1 with the key) each time. The obvious way around this is to cache the key derived from the password. But caching the key is dangerous. With a copy of this key, an attacker could impersonate the user at any time (until the password is next changed).

Kerberos resolves this problem by introducing a new agent, called the “ticket granting server” (TGS). The TGS is logically distinct from the AS, although they may reside on the same physical machine. They are collectively referred to as Key Distribution Center (KDC).

FIG. 2B is schematic diagram showing the function of the TGS 106. Before accessing any regular service 105, the user 101 requests a ticket from AS 104 to contact the TGS 106, just as if it were any other service. This ticket is called the ticket granting ticket (TGT).

After receiving the TGT, any time that the user 101 wishes to contact a service 105, he requests a new ticket not from the AS 104, but from the TGS 106. Furthermore, the reply is encrypted not with the user's secret key, but with the session key that the AS 104 provided for use with the TGS 106. Inside that reply is the new session key for use with the regular service 105. The rest of the exchange now continues as described above. Note that in the TGT exchange, the AS 104 and the TGS 106 are logically distinct but are usually physically identical.

The advantage of this method is that while passwords usually remain valid for months at a time, the TGT is good only for a fairly short period, typically eight hours. Afterwards, the TGT is not usable by anyone, including the user or any attacker. This TGT, as well as any tickets that the user obtains using it, are stored in the credentials cache. There are a number of commands that the user can use to manipulate his credentials cache. The term “credentials” actually refers to both the ticket and the session key in conjunction. However, the terms “ticket cache” and “credentials cache” used more or less interchangeably.

The system in FIG. 2B only includes a single AS 104 and a single TGS 106, which may or may not reside on the same machine. As long as the number of requests is small, this is not a problem. But as the network grows, the number of requests grows with it, and the AS/TGS becomes a bottleneck in the authentication process. In other words, this system does not scale. Therefore, it is advantageous to divide the network into realms. These divisions are often made on organizational boundaries, although they need not be. Each realm has its own AS and its own TGS. To allow for cross-realm authentication, i.e. to allow users in one realm to access services in another, it is necessary first for the user's realm to register a remote TGS (RTGS) in the service's realm.

Recall that when the TGS was added, an additional exchange was added to the protocol. Here, yet another exchange is added: First, the user contacts the AS 104 to access the TGS 106. Then the user contacts the TGS 106 to access the RTGS. Finally, the user contacts the RTGS to access the actual service. Actually, it can be worse than that. In some cases, where there are many realms, it is inefficient to register each realm in every other realm.

Instead, there is a hierarchy of realms, so that in order to contact a service in another realm, it may be necessary to contact the RTGS in one or more intermediate realms. The names of each of these realms is recorded in the ticket.

Kerberos is becoming increasingly important as a single sign-on system for the Internet. However, existing web browsers cannot work Kerberos. This invention enables such usage.

The invention provides a system and system for authenticating Kerberos users on common web browsers in a distributed network comprising a number of clients, a gateway server acting as a gateway that converts information from a normal browser to normal Kerberos traffic, and a number of service providers, which are communicatively coupled to each other via the Internet.

The gateway server is coupled to a key distribution center (KDC) that maintains Kerberos user accounts and comprises an authentication server (AS) and a ticket granting server (TGS). Every service provider shares a key with the KDC sitting behind the gateway.

In the first preferred embodiment, the gateway logic is used and the system does not require JavaScript on the client site. The method comprises the following steps:

submitting a user's identification and password to said gateway server from a browser in a client;

creating, by said gateway server, a first request packet based on said user's identification;

submitting said first request packet to said KDC, wherein said AS makes up a session key and a first ticket for said TGS;

returning, by said KDC, a failure message or a first reply packet to said gateway server;

if a first reply packet is returned, decrypting said first reply packet by said gateway server to extract said session key and said first ticket;

storing said session key and said first ticket in said gateway server's secure domain cookie;

submitting, by said client, a service request to a service provider;

redirecting, by said service provider, said service request with said service provider's identification to said gateway server;

creating, by said gateway server, a second request packet based on said session key, said first ticket, and said service provider's identification;

submitting, by said gateway server, said second request packet to said KDC, wherein said TGS grants a second ticket for said service provider;

returning, by said KDC, a failure message or a second reply packet to said gateway server, and

if a second reply packet is returned, decrypting, by said gateway server, said second reply packet to extract said second ticket;

redirecting, by said gateway server, said service request with said second ticket to said service provider; and

authenticating said user by checking said second ticket.

In another preferred embodiment, the method comprises the steps of:

logging in by entering a user's identification and password from a browser in a client;

creating, using JavaScript, a first request packet based on said user's identification;

submitting said first request packet to said KDC wherein said AS makes up a session key and a first ticket for said TGS;

returning, by said KDC, a failure message or a first reply packet to said gateway server;

if a first reply message is returned, decrypting, by JavaScript, said first reply packet using said user's password;

storing said session key and said first key in said gateway server's secure domain cookie;

submitting, by said client, a service request to a service provider;

redirecting, by said service provider, said service request with said service provider's identification to said gateway server;

creating, by said gateway server, a second request packet based on said session key, said first ticket, and said service provider's identification;

submitting, by said gateway server, said second request packet to said KDC, wherein said TGS grants a second ticket for said service provider;

returning, by said KDC, a failure message or a second reply packet to said gateway server, and

if a second reply packet is returned, decrypting, by said gateway server, said second reply packet to extract said second ticket;

redirecting, by said gateway server, said service request with said second ticket to said service provider; and

authenticating said user by checking said second ticket.

The step of submitting said first request packet to said KDC further comprises the steps of:

encoding said first request packet using JavaScript;

placing said encoded packet in a field of a hidden form;

submitting, by JavaScript, said hidden form to said gateway server;

decoding, by said gateway server, said hidden form; and

submitting, by said gateway server, said decoded packet to said KDC.

In another preferred embodiment, the method further comprises the steps of:

encoding, by said gateway server, said first reply packet;

wrapping, by said gateway server, said encoded packet in a text/html message; and

decoding, by JavaScript, said encoded packet.

In another preferred embodiment, the step of submitting said first request packet to said KDC further comprises the steps of:

encoding said first request packet using JavaScript;

submitting, by JavaScript, said encoded packet to said gateway server using XMLHTTPRequest;

decoding, by said gateway server, said encoded packet; and

submitting said decoded packet to said KDC.

### BRIEF DESCRIPTION OF THE DRAWINGS

FIG. 1A is a block diagram illustrating a Magic Carpet Network (MCN) 100 that facilitates distributed authentication service;

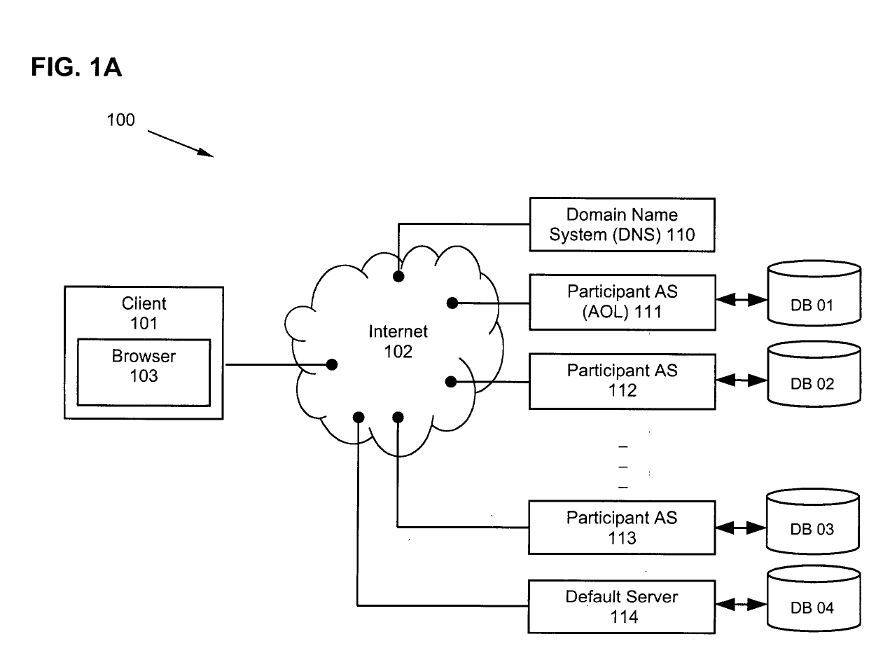

FIG. 1B is a schematic diagram illustrating an exemplary domain name system (DNS) 110 incorporated in a global network;

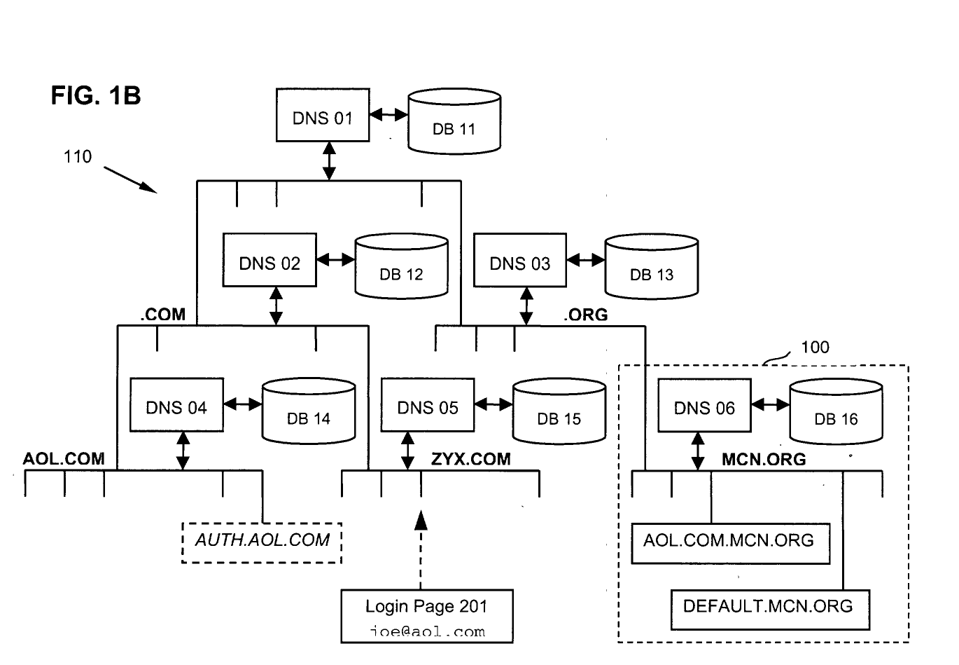

FIG. 1C is a table diagram illustrating an IP address database associated with the domain name server DNS 06 in the network 100;

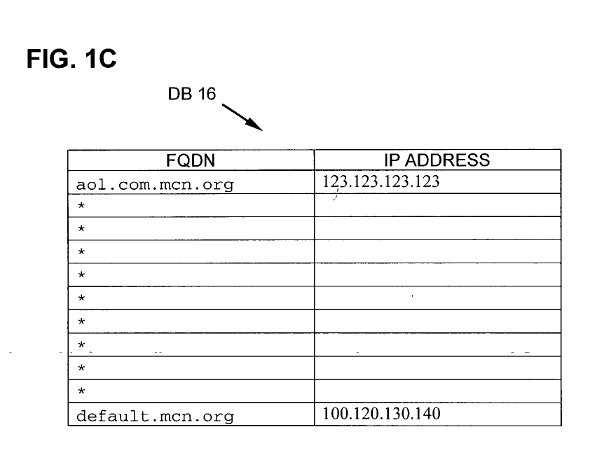

FIG. 2A is a schematic diagram illustrating a basic Kerberos model according to the prior art;

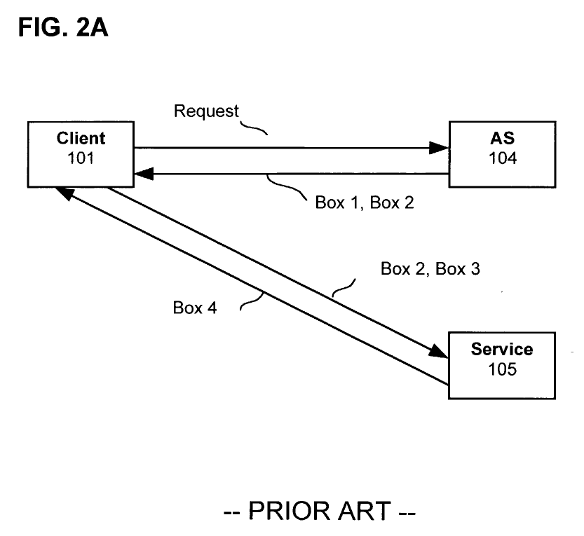

FIG. 2B is a schematic diagram illustrating an extended Kerberos model according to the prior art;

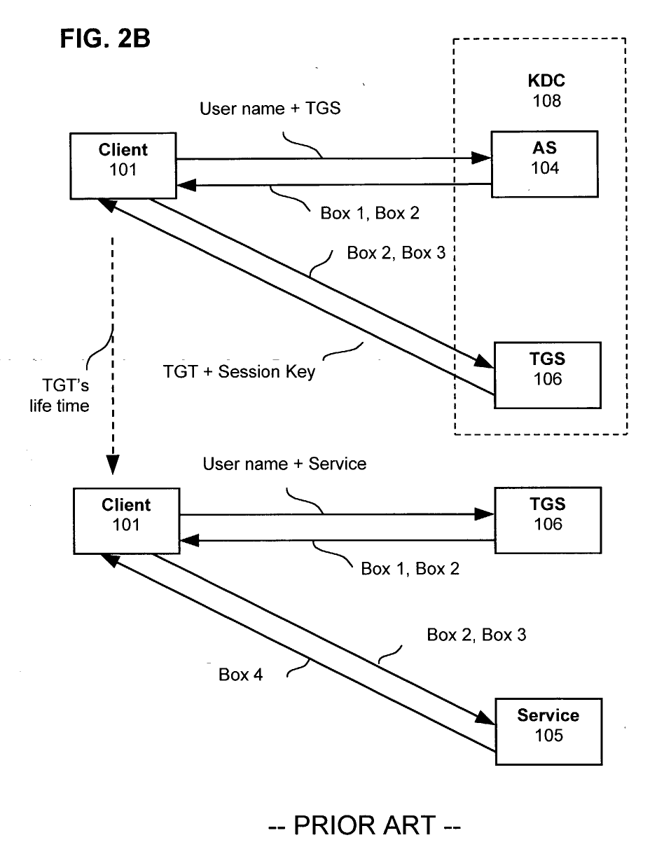

FIG. 3A is a high-level overview of the solution according to the invention;

FIG. 3B is a schematic block diagram illustrating a Magic Carpet Network (MCN) 300 that facilitates Kerberos authentication service;

FIG. 3C is a schematic flow diagram illustrating the authentication method according to one embodiment of the invention;

FIG. 4 is a flow diagram illustrating the steps for MCN login using JavaScript;

FIG. 5 is a flow diagram illustrating the steps for MCN login using gateway-only logic;

FIG. 6 is a flow diagram illustrating the steps for tunneling KRB_* packets through HTTP/HTML using iframe; and

FIG. 7 is a flow diagram illustrating the steps for tunneling KRB_* packets through HTTP/HTML using XMLHTTPRequest.

### DETALED DESCRIPTION

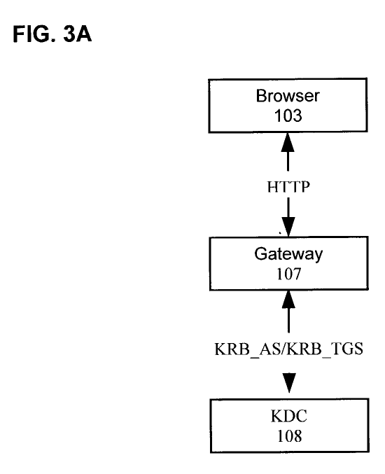

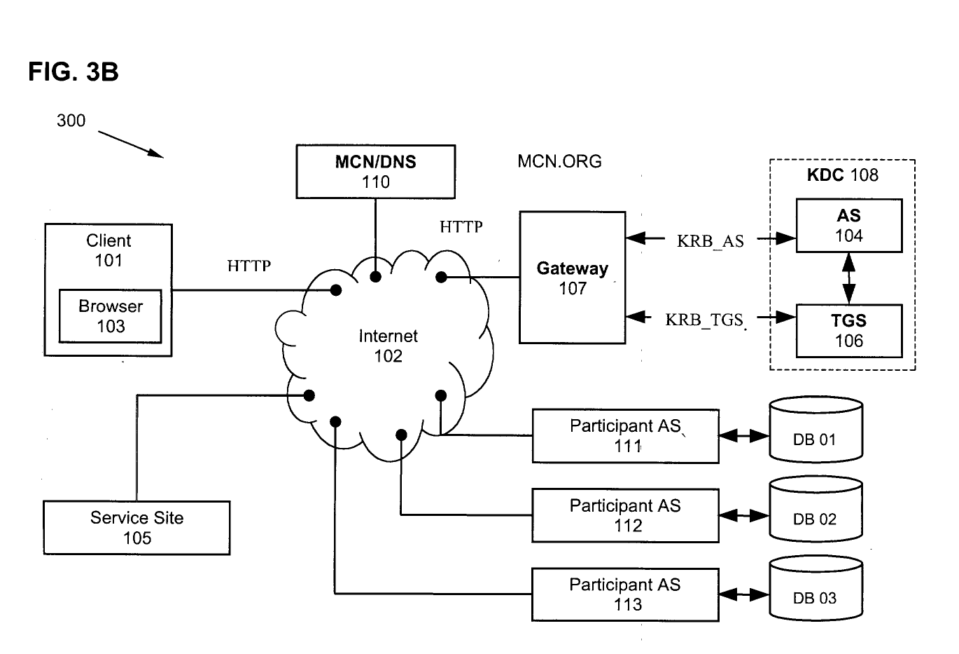

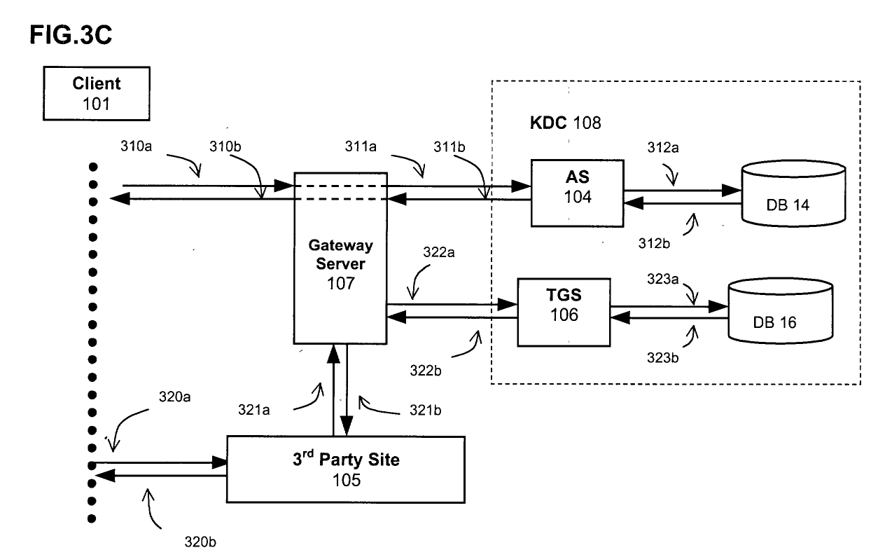

FIG. 3A is a block diagram illustrating a high-level overview of the solution for authenticating Kerberos users from common web-browsers, where a normal web browser 103 is capable of rendering HTML and optionally running JavaScript, a web server acts as a gateway 107 that converts Kerberos on web browsers to normal Kerberos traffic, and a Kerberos Distribution Center (KDC) 108 which maintains Kerberos user accounts.

FIG. 3B is a schematic block diagram illustrating a Magic Carpet Network (MCN) 300 that facilitates Kerberos authentication service, wherein the KDC 108 includes an authentication server (AS) 104 and a Ticket Granting Server (TGS) 106. There are a number of service provider's servers such as service site 105 coupled to the MCN.

FIG. 3C is a schematic flow diagram illustrating an authentication process according to one preferred embodiment. To get service from a third party site 105, Client 101 must perform two tasks in two stages:

Task 1, Client 101 requests a TGT and a first session key:

Step 310a: Client 101 requests a ticket granting ticket (TGT) and the first session key from Gateway 107. The request includes a user ID and password;

Step 311a: Gateway Server 107 takes the user ID and password, uses them to create the KRB_AS_REQ packet, and sends the KRB_AS_REQ packet to the AS 104;

Step 312a/b: AS 104 looks up the user's private key from database DB14, and derives TGT and the first session key, and encrypts the TGT and the first session key with the user's private key, then AS 104 creates either KRB_ERROR or KRB_AS_REP packet based on success of the process;

Step 311b: AS 104 returns KRB_ERROR or KRB_AS_REP packet to the Gateway Server 107;

Step 310b: Gateway Server 107 decrypts the ciphertext part of KRB_AS_REP by using the password, and extracts the TGT and the first session key, and stores them in a secure gateway-domain cookie, and returns a response to Client 101.

Task 2, Client 101 requests a service from Third Party Site 105:

Step 320a: Client 101 requests a service to Third Party Site 105;

Step 321a: Third Party Site 105 redirects the request to Gateway Server 107 by using an HTTP 302. The request includes the Third Party Site's name in the redirected URL;

Step 322a: Gateway Server 107 takes the first session key, the TGT and the website name and uses them to create the KRB_TGS_REQ packet. The Gateway Server 107 sends the KRB_TGS_REQ packet to the TGS 106;

Step 323a/b: TGS 106 looks up Third Party Server's key from database DB16 using the website name, derives a site ticket, and encrypts the site ticket with the first session key, then creates either KRB_ERROR or KRB_TGS_REP based on success of the process;

Step 322b: TGS returns either KRB_ERROR or KRB_TGS_REP to Gateway Server 107;

Step 321b: Gateway Server 107 uses the first session key to decrypt the ciphertext part of the KRB_TGS_REP packet, extracts the site ticket, and returns the site ticket to Third Party Server; and

Step 320b: Third Party Server 105 authenticates the user by checking the returned site ticket, processes Client 101's service request, and returns the processed result to Client 101.

The following description gives more details concerning the steps in different stages.

1. MCN Login

MCN login can be either JavaScript based, or gateway based. In the JavaScript based approach, the user's password is not revealed to the gateway. In the gateway-based approach, the system does not require JavaScript on the client side.

1.1 KRB_AS Using JavaScript

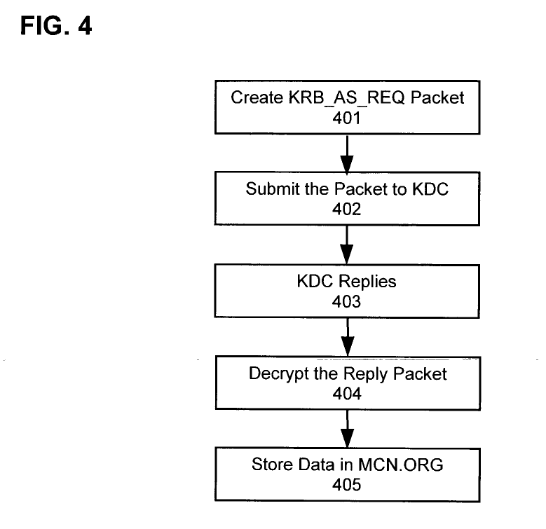

FIG. 4 is a flow diagram illustrating a method for MCN login using JavaScript according to the preferred embodiment. The method includes the following steps:

Step 401: JavaScript creates an authentication request packet (KRB_AS_REQ);

Step 402: JavaScript submits the packet to the KDC 108 using tunneling;

Step 403: The KDC responds with an error message (KRB_ERROR) or a reply packet (KRB_AS_REP);

Step 404: JavaScript uses the user's password to decrypt the ciphertext part of the reply packet (KRB_AS_REP);

Step 405: JavaScript stores the resulting data in a gateway-domain cookie (MCN.ORG). The data includes a TGT and a session key to be used for communications with the TGS 106. For enhancing security, the gateway-domain cookie can be marked secure, i.e., only sent during HTTPS requests to the gateway.

1.2 KRB_AS Using Gateway-Only Logic

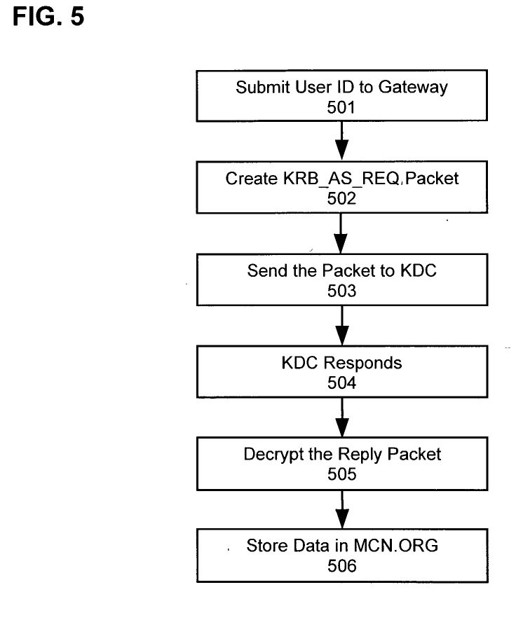

FIG. 5 is a flow diagram illustrating a method for MCN login using gateway-only logic according to another preferred embodiment. The method includes the following steps:

Step 501: The username/password get submitted to a gateway (form POST);

Step 502: The gateway creates a request packet (KRB_AS_REQ);

Step 503: The gateway sends the request packet (KRB_AS_REQ) to the KDC;

Step 504: The KDC responds with an error message (KRB_ERROR) or a reply packet (KRB_AS_REP);

Step 505: The gateway uses the user's password to decrypt the ciphertext part of the reply packet (KRB_AS_REP);

Step 506: The gateway stores the resulting data in a gateway-domain cookie (MCN.ORG) using a Set-Cookie header. The data includes the TGT and the session key to be used for communications with the TGS. For enhancing security, the gateway-domain cookie can be marked secure, i.e., only sent during HTTPS requests to the gateway.

2. Site Login

Assuming that MCN login has already taken place and that there is an MCN.ORG cookie which contains the TGT and the corresponding session key, the user may login a target service site either by a gateway-only method or a JavaScript-based method. A gateway-only method is preferred in this invention.

2.1 Site to MCN.ORG Redirect

The 3rd party site redirects to MCN.ORG by using an HTTP 302. It includes its name in the redirected URL. The browser sends the TGT cookie as part of the MCN.ORG request. Note that if the TGT is not present or has expired, the user must supply his credentials again.

2.2 KRB_TGS

The gateway takes the TGS session key, the TGT and the requesting website name and uses them to create the KRB_TGS_REQ packet. The gateway sends the KRB_TGS_REQ packet to the KDC. The KDC responds with an error message (KRB_ERROR) or a reply packet (KRB_TGS_REP). The gateway uses the session key to decrypt the ciphertext part of the KRB_TGS_REP packet, thus extracting the site ticket.

2.3 MCN.ORG to Site Redirect

The gateway returns a 302 redirect to the 3rd party site. The requested URL includes the site ticket. The browser requests the resource pointed by the URL, thus sending the site ticket.

3. HTTP/HTML Tunneling

Finally, described below are two methods for tunneling KRB_* packets through HTTP/HTML: iframe targeting and XMLHTTPRequest.

3.1. IFRAME Targeting

A web page contains an iframe and a hidden form that targets the iframe. The packet to be transmitted gets base64 encoded using JavaScript and is then placed within a field of the hidden form. The hidden form gets submitted by JavaScript (using POST).

Now referring back to FIG. 3B, the submitted form arrives at the gateway 107 as url-encoded data. The gateway 107 extracts the KRB_* packet, base64 decodes it and sends it to the KDC 108. The KDC 108 responds with its own packet. The gateway 107 receives the KDC response; base64 encodes it and wraps it inside a text/html response, which it then sends to the browser 103.

The onload event of this page contains a call to a method of the parent window (the assumption is that this parent window got served from the same server of course). The following is an exemplary code for this HTML page:

<html><head><script>

var response=“ . . . KRB_*_REP . . . ”; //base64 encoded

</script></head>

<body onload=“parent.packetReceived(response)”></body>

</html>

The JavaScript method receives the response and base64 decodes it, and then proceeds to use it according to other requirements.

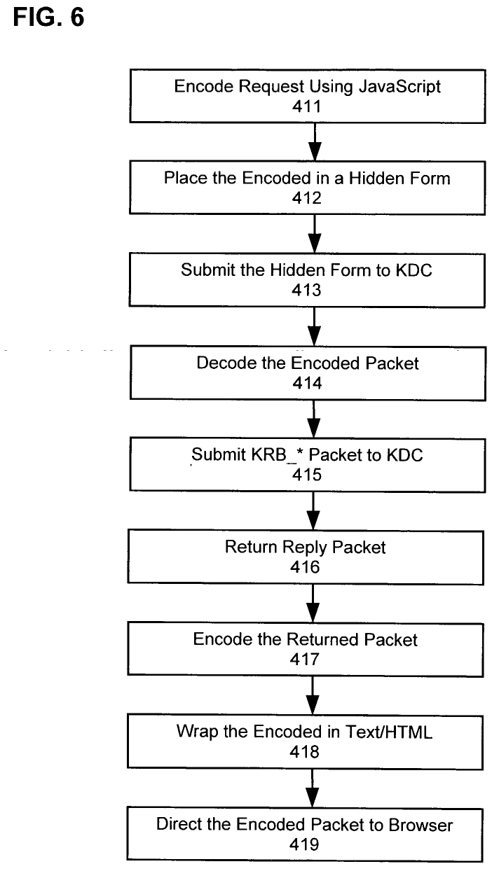

FIG. 6 is a flow diagram illustrating the steps of HTTP/HTML tunneling using iframe targeting:

Step 411: Base64-encoding the authentication request packet using JavaScript;

Step 412: Placing the encoded packet in a field of a hidden form;

Step 413: Submitting, by JavaScript, the hidden form to gateway 107 using POST.

Step 414: Base64-decoding, by the gateway 107, the encoded packet;

Step 415: Submitting the resulting KRB_* packet to the KDC 108;

Step 416: Returning, by the KDC 108, a first reply packet (KRB_*_REP or KRB_ERROR),

Step 417: Base64-encoding the first reply packet, by the gateway 107,

Step 418: Wrapping the encoded packet inside a text/html message; and

Step 419: Directing the text/html message to the browser 103.

3.2 XMLHTTPREQUEST

MSIE 5+ and Netscape 6+ include an object called XMLHTTPRequest, which can be used to execute GET and POST requests from JavaScript. Despite its name, XMLHTTPRequest can be used for more than XML exchange over HTTP. In particular it can be used to exchange arbitrary data embedded in a POST request and the corresponding HTTP response.

In this scheme the packet to be transmitted gets base64 encoded again and is placed inside the body of a POST request by using the functionality of XMLHTTPRequest. The POST request arrives at the gateway 107 which takes the request body, base64 decodes it and sends it to the KDC 108. The KDC 108 responds with its own packet. The new packet gets base64 encoded and is then placed in the body of the gateway's response, which is then sent to the browser 103. JavaScript extracts the base64 encoded KDC response and decodes it. This packet is now ready for further processing.

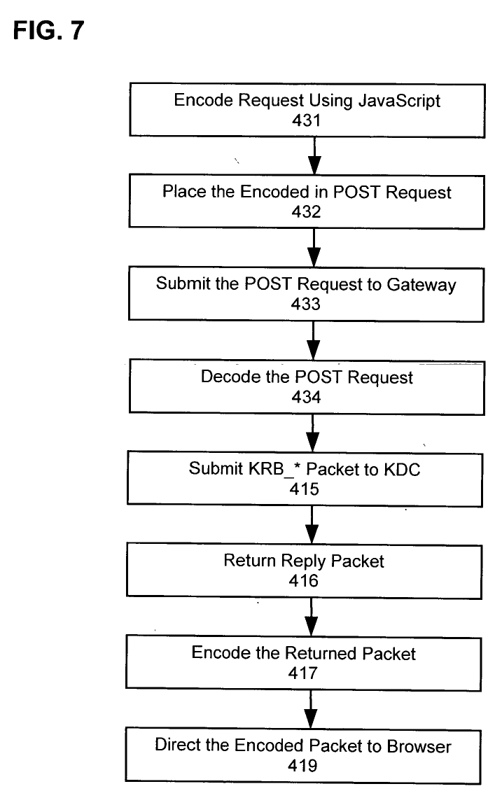

FIG. 7 is a flow diagram illustrating the steps of HTTP/HTML tunneling using XMLHTTPREQUEST:

Step 431: Base64-encoding the authentication request packet using JavaScript;

Step 432: Placing the encoded packet in a POST request by using the functionality of an XMLHTTPRequest object;

Step 433: Submitting, by JavaScript, the POST request to the gateway server 107;

Step 434: Decoding, by the gateway server 107, the POST request; and

Step 415: Submitting the resulting KRB_* packet to the KDC 108;

416: Returning, by the KDC 108, a first reply packet (KRB_*_REP or KRB_ERROR),

Step 417: Base64-encoding the first reply packet, by the gateway 107,

Step 419: Directing the encoded packet to the browser 103.

Although the invention is described herein with reference to the preferred embodiment, one skilled in the art will readily appreciate that other applications may be substituted for those set forth herein without departing from the spirit and scope of the present invention.

Accordingly, the invention should only be limited by the claims included below.

1. In a communications network comprising at least one client, a gateway server, and at least one service provider, which are communicatively coupled to each other via the Internet, wherein said gateway server is coupled to a key distribution center (KDC) which comprises an authentication server (AS) and a ticket granting server (TGS), a method for authenticating a user from common web browsers, comprising the steps of:
submitting said user's identification and password to said gateway server from a browser in a client;
creating, by said gateway server, a first request packet based on said user's identification;
submitting said first request packet to said KDC, wherein said AS makes up a session key and a first ticket for said TGS;
returning, by said KDC, a failure message or a first reply packet to said gateway server;
if a first reply packet is returned, decrypting said first reply packet by said gateway server to extract said session key and said first ticket;
storing said session key and said first ticket in said gateway server's secure domain cookie;
submitting, by said client, a service request to a service provider;
redirecting, by said service provider, said service request with said service provider's identification to said gateway server;
creating, by said gateway server, a second request packet based on said session key, said first ticket, and said service provider's identification;
submitting, by said gateway server, said second request packet to said KDC, wherein said TGS grants a second ticket for said service provider;
returning, by said KDC, a failure message or a second reply packet to said gateway server, and
if a second reply packet is returned, decrypting, by said gateway server, said second reply packet to extract said second ticket;
redirecting, by said gateway server, said service request with said second ticket to said service provider; and
authenticating said user by checking said second ticket.

2. In a communications network comprising at least one client, a gateway server, and at least one service provider, which are communicatively coupled to each other via the Internet, wherein said gateway server is coupled to a key distribution center (KDC) which comprises an authentication server (AS) and a ticket granting server (TGS), a method for authenticating a user from common web browsers, comprising the steps of:
logging in by entering said user's identification and password from a browser in a client;
creating, using JavaScript, a first request packet based on said user's identification;
submitting said first request packet to said KDC, wherein said AS makes up a session key and a first ticket for said TGS;
returning, by said KDC, a failure message or a first reply packet to said gateway server;
if a first reply message is returned, decrypting, by JavaScript, said first reply packet using said user's password;
storing said session key and said first key in said gateway server's secure domain cookie;
submitting, by said client, a service request to a service provider;
redirecting, by said service provider, said service request with said service provider's identification to said gateway server;
creating, by said gateway server, a second request packet based on said session key, said first ticket, and said service provider's identification;
submitting, by said gateway server, said second request packet to said KDC, wherein said TGS grants a second ticket for said service provider;
returning, by said KDC, a failure message or a second reply packet to said gateway server, and
if a second reply packet is returned, decrypting, by said gateway server, said second reply packet to extract said second ticket;
redirecting, by said gateway server, said service request with said second ticket to said service provider; and
authenticating said user by checking said second ticket.

3. The method of claim 2, wherein the step of submitting said first request packet to said KDC comprises the sub-steps of:
encoding said first request packet using JavaScript;
placing said encoded packet in a field of a hidden form;
submitting, by JavaScript, said hidden form to said gateway server;
decoding, by said gateway server, said hidden form; and
submitting, by said gateway server, said decoded packet to said KDC.

4. The method of claim 2, further comprising the steps of:
encoding, by said gateway server, said first reply packet;
wrapping, by said gateway server, said encoded packet in a text/html message; and
decoding, by JavaScript, said encoded packet.

5. The method of claim 2, wherein the step of submitting said first request packet to said KDC comprises the sub-steps of:
encoding said first request packet using JavaScript;
submitting, by JavaScript, said encoded packet to said gateway server using XMLHTTPRequest;
decoding, by said gateway server, said encoded packet; and
submitting said decoded packet to said KDC.

6. A communications network comprising:
at least one client communicatively coupled to the Internet;
at least one service provider communicatively coupled to the Internet;
a key distribution center communicatively coupled to the Internet; and
a gateway server for converting information from a normal browser in a client to data traffic acceptable for said key distribution center.

7. The communications network of claim 6, wherein said gateway server comprises:
means for encoding and decoding; and
means for storing processed data in a secure domain cookie.
